(19) United States
(12) Patent Application Publication
(10) Pub. No.: US 2018/0061408 A1
(43) Pub. Date: Mar. 1, 2018

(54) USING PARAPHRASE IN ACCEPTING UTTERANCES IN AN AUTOMATED ASSISTANT

(71) Applicant: Semantic Machines, Inc., Berkeley, CA (US)

(72) Inventors: Jacob Daniel Andreas, Berkeley, CA (US); David Ernesto Heekin Burkett, Berkeley, CA (US); Pengyu Chen, Cupertino, CA (US); Jordan Rian Cohen, Kure Beach, NC (US); Gregory Christopher Durrett, Berkeley, CA (US); Laurence Steven Gillick, Newton, MA (US); David Leo Wright Hall, Berkeley, CA (US); Daniel Klein, Orinda, CA (US); Adam David Pauls, Berekeley, CA (US); Daniel Lawrence Roth, Newton, MS (US); Jesse Daniele Eskes Rusak, Somerville, MA (US); Yan Virin, Foster City, CA (US); Charles Clayton Wooters, Livermore, CA (US)

(73) Assignee: Semantic Machines, Inc., Berkeley, CA (US)

(21) Appl. No.: 15/669,795

(22) Filed: Aug. 4, 2017

Related U.S. Application Data
(60) Provisional application No. 62/379,152, filed on Aug. 24, 2016.

(51) Int. Cl. G10L 15/22; G10L 15/06; G10L 15/18

(52) U.S. Cl. CPC G10L 15/22; G10L 2015/088; G10L 15/1822; G10L 15/063

(57) ABSTRACT

An automated assistant automatically recognizes speech, decode paraphrases in the recognized speech, performs an action or task based on the decoder output, and provides a response to the user. The response may be text or audio, and may be translated to include paraphrasing. The automatically recognized speech may be processed to determine partitions in the speech, which may be in turn processed to identify paraphrases in the partitions. A decoder may process an input utterance text to identify paraphrases content to include in a segment or sentence. The decoder may paraphrase the input utterance to make the utterance, updated with one or more paraphrases, more easily parsed by a parser. A translator may process a generated response to make the response sound more natural. The translator may replace content of the generated response with paraphrase content based on the state of the conversation with the user, including salience data.

### SUMMARY

A system may include an automated assistant that receives and automatically recognizes speech from a user, decodes paraphrases in the recognized speech or transduces the recognized speech, performs an action or task based on the decoder/transducer output, and provides a response to the user. The response may be text or audio, and may be translated to include paraphrasing. The automatically recognized speech may be processed to determine partitions in the speech, which may be in turn processed to identify paraphrases in the partitions.

A decoder may process an input utterance text to identify paraphrases content to include in segment or sentence. The decoder may paraphrase the input utterance to make the utterance, updated with one or more paraphrases, more easily parsed by parser 220. The input utterance may be parsed using trigger phrases such as training sentences or segments.

A translator may process a generated response to make the response sound more natural. The translator may replace content of the generated response with paraphrase content based on the state of the conversation with the user, including salience data.

In some instances, a system providing an automated assistant may include an automatic speech recognition module and a paraphrase decoder. The automatic speech recognition module can be stored in memory and executable by a processor such that when executed, the automatic speech recognition module receives speech data, recognizes words of a language in the speech, and outputs word data based on the recognized words. The paraphrase decoder can be stored in memory and executable by a processor such that when executed, the paraphrase decoder identifies a first set of one or more words in the recognized words, selects a paraphrase associated with the first set of words, and generates a paraphrase decoder output including a paraphrase associated with the first set of words and the recognized words other than the first set of words. The paraphrase can be selected based on trigger phrases associated with a parser.

In some instances, a system providing an automated assistant may include an automatic speech recognition module and a paraphrase translator. The generator module can be stored in memory and executable by a processor such that when executed, the module receives a speech structure form and renders a string of words based on the structure form. The paraphrase translator can be stored in memory and executable by a processor such that when executed, the translator identifies a first set of words in the string of words, selects a paraphrase associated with the first set of words, and generates a paraphrase translator output including a paraphrase associated with the first set of words and the recognized words other than the first set of words. The paraphrase can be selected based at least in part on state information.

### BRIEF DESCRIPTION OF FIGURES

FIG. 1 is a block diagram of an automated assistant that uses paraphrases.

FIG. 2 is a block diagram of a server-side implementation of an automated assistant that uses paraphrases.

FIG. 3 is a method for providing an automated assistant that uses paraphrases.

FIG. 4 is a block diagram representing a sausage network.

FIG. 5 is a method for replacing segments of language input with paraphrases by a decoder.

FIG. 6 is a flowchart showing a paraphrase provided by decoder and added to an utterance.

FIG. 7 is a method for updating and output with paraphrase by a translator.

FIG. 8 is a flowchart showing a paraphrase provided by a translator and added to the generated output.

FIG. 9 illustrates a computing environment for implementing the present technology.

### DETAILED DESCRIPTION

A system may include an automated assistant that receives and automatically recognizes speech from a user, decodes text from the recognized speech into paraphrases, performs an action or task based on the decoder/transducer output, and provides a response to the user. The response may be text or audio, and may be translated to include paraphrasing. The automatically recognized speech may be processed to determine partitions in the speech, which may be in turn processed to identify paraphrases in the partitions.

A user of natural language has many ways to confer meaning to a listener. Given one sentence, a user can sensibly ask for a second sentence that has the same “meaning”. In an automated assistant application, a user communicates with speech or text, and the system responds with language (text or speech) and/or actions (like looking up the price of a ticket). The context of the present system is an automated assistant.

Paraphrase may be used to modify the utterances of the user to be more likely to create the appropriate agent response (decoder implementation) or it may be used to modify the agent replies to appear more natural to the user (translator implementation). In either case, it is the intent that the paraphrased utterance carries the same meaning as the non-paraphrased utterance: in the first case the system response to a user's request should be an appropriate response to the user's original utterance, and in the second case the system's information delivery to the user should contain the same information as the original system response.

A decoder may process an input utterance text to identify paraphrases content to include in segment or sentence. The decoder may paraphrase the input utterance to make the utterance, updated with one or more paraphrases, more easily parsed by parser 220. The input utterance may be parsed using trigger phrases such as training sentences or segments.

A translator may process a generated response to make the response sound more natural. The translator may replace content of the generated response with paraphrase content based on the state of the conversation with the user, including salience data.

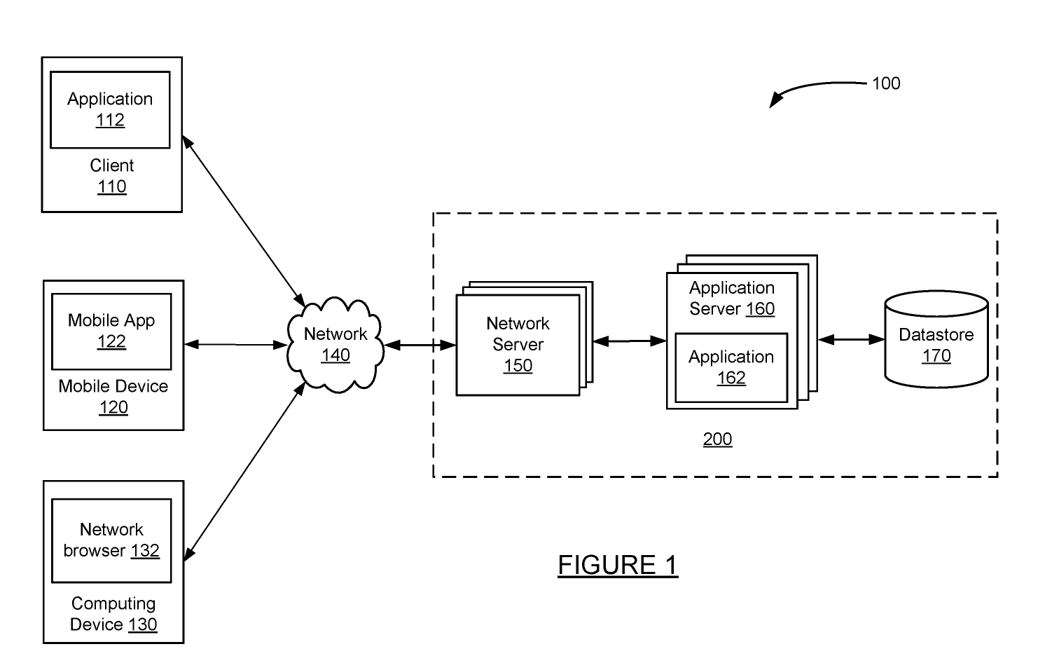

FIG. 1 is a block diagram of a system that implements an automated assistant that uses paraphrases to accept utterances. System 100 of FIG. 1 includes client 110, mobile device 120, computing device 130, network 140, network server 150, application server 160, and data store 170. Client 110, mobile device 120, and computing device 130 communicate with network server 150 over network 140. Network 140 may include a private network, public network, the Internet, and intranet, a WAN, a LAN, a cellular network, or some other network suitable for the transmission of data between computing devices of FIG. 1.

Client 110 includes application 112. Application 112 may provide automatic speech recognition, paraphrase decoding, transducing and/or translation, paraphrase translation, partitioning, an automated assistant, and other functionality discussed herein. Application 112 may be implemented as one or more applications, objects, modules or other software. Application 112 may communicate with application server 160 and data store 170, through the server architecture of FIG. 1 or directly (not illustrated in FIG. 1) to access the large amounts of data.

Mobile device 120 may include a mobile application 122. The mobile application may provide automatic speech recognition, paraphrase decoding, transducing and/or translation, paraphrase translation, partitioning, an automated assistant, and other functionality discussed herein. Mobile application 122 may be implemented as one or more applications, objects, modules or other software.

Computing device 130 may include a network browser 132. The network browser may receive one or more content pages, script code and other code that when loaded into the network browser provides automatic speech recognition, paraphrase decoding, transducing and/or translation, paraphrase translation, partitioning, an automated assistant, and other functionality discussed herein.

Network server 150 may receive requests and data from application 112, mobile application 122, and network browser 132 via network 140. The request may be initiated by the particular applications or browser applications. Network server 150 may process the request and data, transmit a response, or transmit the request and data or other content to application server 160.

Application server 160 includes application 162. The application server may receive data, including data requests received from applications 112 and 122 and browser 132, process the data, and transmit a response to network server 150. In some implementations, the responses are forwarded by network server 152 to the computer or application that originally sent the request. Application's server 160 may also communicate with data store 170. For example, data can be accessed from data store 170 to be used by an application to provide automatic speech recognition, paraphrase decoding, transducing and/or translation, paraphrase translation, partitioning, an automated assistant, and other functionality discussed herein. Application server 160 includes application 162, which may operate similar to application 112 except implemented all or in part on application server 160.

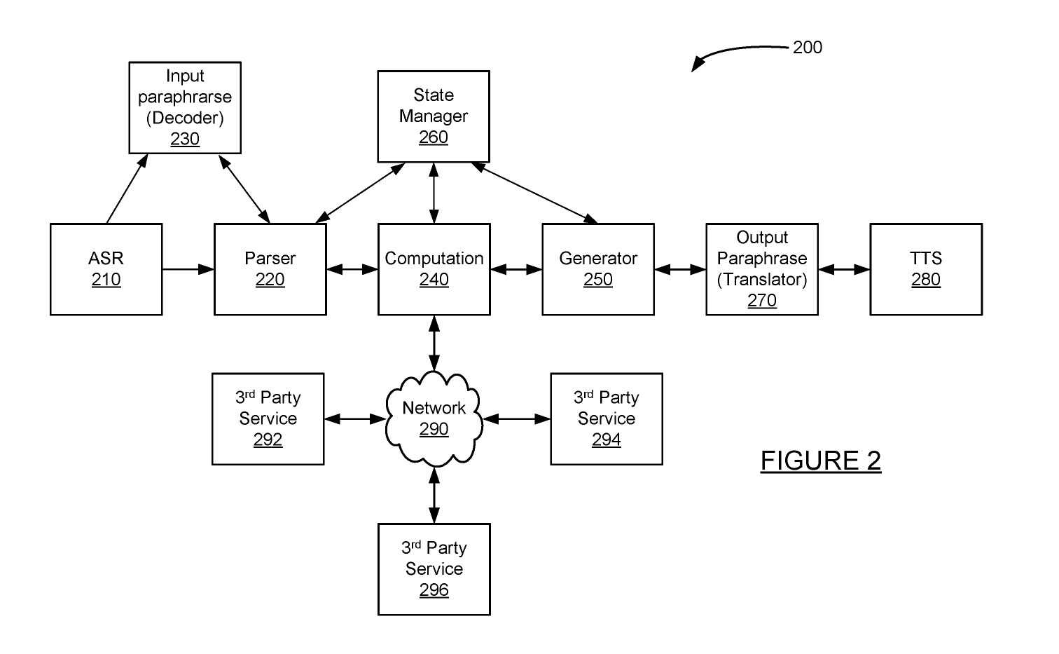

Block 200 includes network server 150, application server 160, and data store 170, and may be used to implement an automated assistant that utilizes paraphrases. In some instances, block 200 may include a paraphrase module to process an input utterance to make the utterance more easily parsable. In some instances, Block 200 may include a paraphrase module two process a generated output in order to make it more natural to a user. Block 200 is discussed in more detail with respect to FIG. 2.

FIG. 2 is a block diagram of a server-side portion of an automated assistant that utilizes paraphrases. System 200 of FIG. 2 includes automatic speech recognition (ASR) module 210, parser 220, input paraphrase module (decoder) 230, computation module 240, generator 250, state manager 260, output paraphrase module (translator) 270, and text to speech (TTS) module 280. Each of the modules may communicate as indicated with arrows and may additionally communicate with other modules, machines or systems, which may or may not be illustrated FIG. 2.

Automatic speech recognition module 210 may receive audio content, such as content received through a microphone from one of client 110, mobile device 120, or computing device 130, and may process the audio content to identify speech. The speech may be provided to decoder 230 as well as parser 220.

Parser 220 may interpret a user utterance into intentions. In some instances, parser 220 may produce a set of candidate responses to an utterance received and recognized by ASR 210. Parser 220 may generate one or more plans, for example by creating one or more cards, using a current dialogue state received from state manager 260. In some instances, parser 220 may select and fill a template using an expression from state manager 260 to create a card and pass the card to computation module 240.

Decoder 230 may decode received utterances into equivalent language that is easier for parser 220 to parse. For example, decoder 230 may decode an utterance into an equivalent training sentence, trading segments, or other content that may be easily parsed by parser 220. The equivalent language is provided to parser 220 by decoder 230.

Computation module 240 may examine candidate responses, such as plans, that are received from parser 220. The computation module may rank them, alter them, may also add to them. In some instances, computation module 240 may add a “do-nothing” action to the candidate responses. Computation module may decide which plan to execute, such as by machine learning or some other method. Once the computation module determines which plan to execute, computation module 240 may communicate with one or more third-party services 292, 294, or 296, to execute the plan. In some instances, executing the plan may involve sending an email through a third-party service, sending a text message through third-party service, accessing information from a third-party service such as flight information, hotel information, or other data. In some instances, identifying a plan and executing a plan may involve generating a response by generator 250 without accessing content from a third-party service.

State manager 260 allows the system to infer what objects a user means when he or she uses a pronoun or generic noun phrase to refer to an entity. The state manager may track “salience” —that is, tracking focus, intent, and history of the interactions. The salience information is available to the paraphrase manipulation systems described here, but the other internal workings of the automated assistant are not observable.

Generator 250 may receive a structured logical response from computation module 240. The structured logical response may be generated as a result of the selection of can at response to execute. When received, generator 250 may generate a natural language response from the logical form to render a string. Generating the natural language response may include rendering a string from key-value pairs, as well as utilizing silence information for information pass along from computation module 240. Once the strings are generated, they are provided to a translator 270.

Translator 270 transforms the output string to a string of language that is more natural to a user. Translator 270 may utilize state information from state manager 260 to generate a paraphrase to be incorporated into the output string. The output of generator 250 is then converted to speech by text-to-speech module 280.

Additional details regarding the modules of Block 200, including a parser, state manager for managing salience information, a generator, and other modules used to implement dialogue management are described in U.S. patent application Ser. No. 15/348, 226 (the '226 application), entitled “interaction assistant,” filed on Nov. 10, 2016, which claims the priority benefit to U.S. provisional patent application 62/254,438, titled “attentive communication assistant,” filed on Nov. 12, 2015, the disclosures of which are incorporated herein by reference.

In an operating automated assistant system, whether the assistant is real or an automaton, given a collection of sentences (or phrases, or words) and their associated actions from the assistant, one may discover paraphrases as a cluster of input utterances that create identical reactions from the system. Identity may be defined as the system reacting to the input utterance with the same output, defined as the same utterance, the same output utterance and action, or the same utterance, action, and salience, depending on the circumstances of the system use. In keeping with the state-of-the-art, paraphrases may also be created from any system input utterance by replacing words or phrases with synonyms, either individually or in multiplicity. (These replacements may also include replacing idioms with appropriate non-idiomatic expressions, like for example replacing “kick the bucket” with “die”.)

For any particular system output, the paraphrases noted in the data or created by synonym replacement may be analyzed by a linguistic model acting as a paraphrase identifier or decoder. This model may be a set of replacement rules, or a grammar, or a neural network, whether an ANN, a convolutional network, an LSTM network (with internal memory), or some other classification model. The model may also be a finite state transducer, which can accept all or most of the synonyms as belonging to a class of utterances that have the same meaning.

In use, given that there is a model which allows the synonyms to be identified, all utterances which are accepted by that model may be replaced by a single established utterance, chosen either to be the easiest for the automated assistant to analyze, or the utterance which the automated assistant assigns the highest confidence, or chosen with some alternate optimizing criterion. Such a model will accept utterances or text strings which are not in the original set of training material, thus extending the acceptance of paraphrased queries outside of the originally observed set. (This is a general characteristic of language models). This model may be considered to “decode” paraphrases to a single canonical representative, and we refer to it below as the Decoder.

A second use of paraphrase is in modifying the output utterances of the automated assistant to be less formulaic and more natural. The automated assistant may create many alternative but equivalent utterances in response to a user query, and the collection of those utterances which have high probability may be sensibly be assumed to be paraphrases of one another. Similarly, those utterances of the automated assistant which stimulate the same response from the user may be considered to be potential paraphrases. As before, in either set of utterances, replacements of single or multiple synonyms may expand the collection of synonymous utterances. (This works whether the assistant is an automaton or a person).

Given a collection of paraphrased automated assistant replies, one can build a language generator which has a high probability of generating any one of the paraphrased replies from each of the others. Such a model, whether neural network, HMM, or grammar based, will overgenerate replies when fed one of the synonymous utterances. (Overgenerated utterances are those utterances which are created by the model, but which did not exist in the training data). These overgenerated replies may then be used to substitute for an originally created utterance, thus providing a more natural feeling/sounding assistant. This model, generating paraphrases from automated assistant utterances, may be considered a machine translation model. We refer to it below as the “translation” model.

In an automated assistant system, whether the assistant is actually a machine or is a person acting for the machine, data to form paraphrases may be collected by analyzing the use of the automated assistant, associating the assistant outputs with the user inputs. In the automated assistant from the '226 application, the automated assistant is trained to act appropriately on almost all of the observed utterances. This training optimizes the system for the utterance collection known at training time. This optimization does not include possible paraphrases explicitly, although some paraphrases of known utterances might result in appropriate actions by the system.

In an alternative embodiment, the utterance of a user is analyzed by a speech recognizer, and is then displayed as a lattice or a sausage network. A sausage network implementation is described here, although a similar implementation may be created with a lattice.

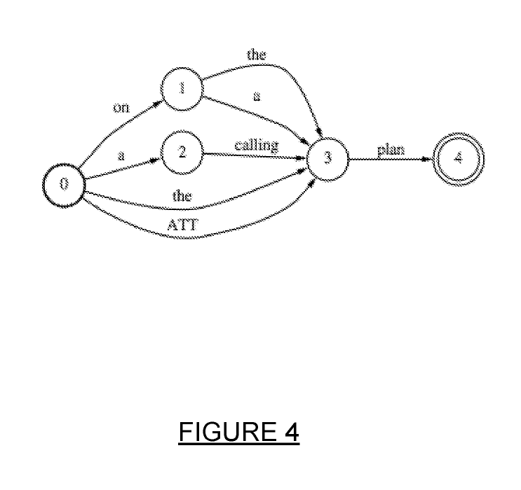

FIG. 4 is a block diagram representing a sausage network. In a sausage network (see FIG. 4), the possible words representing the user's utterance form a directed graph of possible words at each time, but with the constraint that word endings happen at common times. That is, words are represented in time such that between “join” points there are an integer number of words, as can be seen in the figure. Hence, partitioning the speech signal at the join points of the sausage lattice will ensure that whole words are contained in the partition.

In this alternative embodiment, the sausage network (or, similarly, the words of the one-best hypothesis) are collected into all partitions of those words, such that the partitions are restricted to one or more consecutive segments of time in the original utterance. These partitions, or combinations of those partitions, are then acted upon by a semantic parsing engine. The semantic parser identifies the user intent and the information supplied by the user, and then passes that information to “cards” in the automated assistant for further processing. Hence, the semantic parser may discover that the user wants to book a flight, or he is responding to a request for more information (departing city?), or he is clarifying a mis-identified constraint (did you mean Miami?), or some other element of the conversation.

The paraphrase generator may act in two different ways at the input to the automated assistant.

A. It may offer alternative utterances, each of which may be partitioned and passed on to the semantic parser. In this case, the changed words or phrases are acted upon as though the utterance was the original utterance, and the various alternative representations are cycled through in turn until the semantic parser finds one or more actionable alternatives.

B. The paraphrase engine (offering synonyms for words, or other associated lexical replacements) may work on the partitions of the original utterance analysis. In this case, the alternative representations of the partitions may be used in conjunction with the original representations to be submitted to the parser en-masse for appropriate action.

In one embodiment, the language model can predict an observed training utterance from a new utterance, creating a transducer which will score the association between a sentence and each of the training sentences from the automated assistant. This transducer can include a list of the sentences used to train the language model to check before running the transducer, thus catching sentences uttered by the user which were actually in the language model training set. Checking this list before running the transducer can minimize the computation. If the transducer is run, it will produce a score relating the utterance of the user against each of the original training sentences—the highest scoring sentence may then be input to the assistant instead of the actual transcript of the user's utterance. Interacting with the Automated Assistant.

In using the Automated Assistant, a user utters a phrase or types a message to be acted upon by the assistant. The phrase is passed to the decoder(s), and if the utterance is accepted, the output of the decoder is then input to the Automated Assistant. The decoder will produce a parsable sentence (it was trained to produce original input sentences, all or most of which were parsable), and if the input sentence was part of the original training set, it would be decoded as unchanged. The decoded sentence will then be submitted to the assistant for action. Thus, the decoder undoes any paraphrase creation by the user, allowing the system to work within the bounds of the original design and optimization. If the sentence is not accepted by any of the paraphrase models, then the utterance itself is input to the automated assistant

As the automated assistant creates messages to be returned to the user, it may optionally create a paraphrase to return instead of the system generated reply. Measures of user satisfaction may be used to adjust the parameters of this translation system, mitigating the mechanical persona of many automated assistants, and providing a more appealing conversational companion.

The transduction from input paraphrases to training input sentences may be considered a transducer which changes utterances from sentences which are difficult to parse to sentences which are easy to parse (this characteristic being reinforced by the learning and design of the original automated assistant).

There are many possible designs for the transducer, such as those described in the following references:

(Reference: “Semantic Parsing via Paraphrasing” Jonathan Berant, Percy Liang, Proceedings of the 52nd Annual Meeting of the Association for Computational Linguistics, pages 1415-1425, Baltimore, Md., USA, Jun. 23-25, 2014)

(Reference: “Simple PPDB: A Paraphrase Database for Simplification” Ellie Pavlick and Chris Callison-Burch. ACL 2016. http://www.seas.upenn.edu/˜epavlick/papers/simple-ppdb.pdf)
1. The simple decoder. This transducer takes each input utterance and replaces each word with a synonym that is part of the Assistant's lexicon in turn, or in combination. A probability is assigned to each paraphrase inverse, possibly as a function of the number of words changed, or some other feature of the input and output phrases. Each resulting sentence is then submitted to the assistant's parser for action, possibly in probability order. The process terminates upon the first successful high probability parse. Of course, more sophisticated word-by-word replacement schemes may also be used, based on the probability of each replacement, or by some personalized information about the user or the circumstance of the assistant's task. (We avoid countering our initial assumption that we do not look “inside the box” of the automated assistant because the probability of the input being parsed is related to the system output; there are other solutions which evaluate partial parses, and those will violate our original assumption, but may be found to be better performers at the cost of some complexity)
2. A phrase decoder may be built using the original training sentences as targets, and the paraphrased sentences of the user as inputs. The phrase decoder can use a lexicon, parts of speech marking, punctuation, or other markup to assist in the scoring of possible translations. (This type of translation was widely supported by DARPA during the GALE project, started in 2006, and ongoing to today. A system from English to English was developed by Systran and the Canadian Research Council, which created fluent English sentences from phrase-translated sentences derived from a foreign language, but the essentials for such an intra-language translation system were demonstrated). Other similar translation Systems have been designed and fielded by both IBM and by BBN (references here). The phrase decoder outputs may be limited to the original set of training utterances for the automated assistant system.
3. A neural network model may be built which accepts as input a paraphrased utterance, and produces as output one or more (probabilistically ordered) original utterances. The neural network may be shallow or deep, using recurrence or not, and including long-short-term memory elements or not. In any case, the performance of this paraphrase system is expected to be a function of the design of the network, the available training data, and the computing resources of the trainer.

(Reference: A Neural Attention Model for Sentence Summarization Alexander M. Rush, Summit Chopra, Jason Weston, Proceedings of the 2015 Conference on Empirical Methods in Natural Language Processing, pages 379-389, Lisbon, Portugal, 17-21 Sep. 2015)
4. An “auxiliary” system may be built by simply creating a list of utterances seen by the assistant system, in conjunction with language and action responses of the system. (This is essentially a Bot with hand-written rules). While a Neural Network system will be more manageable for enormous data, the list will allow a system to be designed for limited domains. In addition, having such a list either alone or in conjunction with one of the other three systems described above, will allow human tuning of the system, and will allow rapid expansion of the system capabilities to new utterances and new actions. It also allows interactive review of system failures, and easy insertion of corrected actions for known input utterances.
5. A paraphrase transducer may be designed as a general neural network, where the inputs are transcriptions of speech or text strings, and output are any collection of reasonable paraphrases, such as those of the 4 models listed above, or the outputs of any other model. These outputs may contain manually generated as well as automatically generated paraphrases. This general paraphrase transducer may be a simple neural network, a deep network, a convolutional network, an LSTM network, or any other multi-layer probabilistic model. Standard training procedures may be used to adjust the parameters of the model to maximize the performance of the automated assistant.
6. The paraphrase transducer need not provide explicit paraphrases for inputs, but may operate in a “scorer” or “reranker” mode in which it takes both an input phrase and an output paraphrase and assigns a score to that pair indicating how likely the two are paraphrases. Among other uses, during parsing, the system may use this to compare known “trigger phrases” to the input utterance to implicitly determine whether or not the phrase is an acceptable paraphrase.
7. The paraphrase transducer may have a “calibration” or “embedding” step in which it executes a computation on the entire input utterance, the current dialogue state, or both to give the system the ability to conditionally score or produce phrases. For instance, the system may use dialogue context to know whether the phrases “what's it like” in “what's it like in Chicago?” indicates that the user is asking about the weather, or asking about real estate prices, or a question about tourism, or something else.

Whichever paraphrase transducer is used in conjunction with the automated assistant, the output of the system can be either deterministic (one-best) or probabilistic. However, especially in cases where the paraphrases are probabilistic, the probabilities of these paraphrases may be adjusted using standard machine learning techniques. That is, we may learn to adjust the probabilities assigned to each paraphrase associated with a particular input by collecting data about the system performance when that input is presented, including corrected inputs provided by an after-the-fact analysis, and we may then adjust the probabilities associated with the transducer outputs to minimize the system errors for the automated assistant.

The translator system, used to modify system output, may likewise be designed, although the methods used to optimize the system may be different.

In the translator module which replaces words with synonyms, it may be assumed that the user will find those utterances acceptable. However, in some cases synonyms will have alternate meanings which interfere with the original meaning, and failures of the system may be analyzed to minimize the use of those particular synonymous words or phrases in the future systems.

Phrase translation methodology may be used to create alternate utterances/messages from the automated assistant. Like the synonym replacement system noted above, the phrase translator will sometimes create utterances with unexpected meanings, and these will have to be pruned either by an active quality control activity, or by analyzing the use of the system and noting the errors to be fixed in a future instantiation.

And, as above, a simple list with a choice algorithm may be used to provide variability in the output of the automated assistant. The choice may be biased by a probability, assigned at random, or selected by some efficiency criterion created from analyzing the system performance.

The addition of a paraphrase-capable input system will make the Automated Assistant more habitable, more maintainable, and easier to design and build than the standard dialog systems.

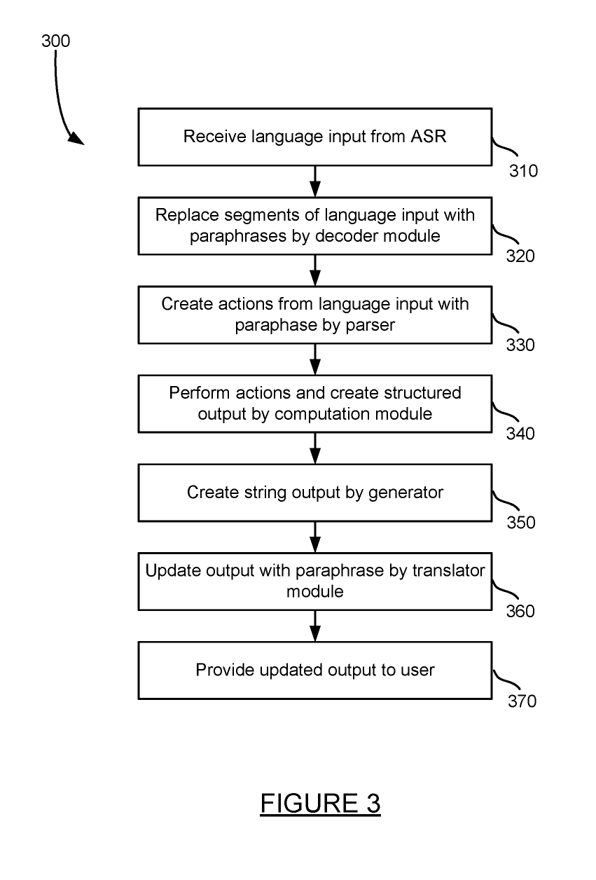

FIG. 3 is a method for providing an automated assistant that uses paraphrases. Language input is received from the automatic speech recognition module 210 at step 310. Language input may be received by both the decoder 230 and parser 220. Input is generated by ASR 210 from audio received by user from a remote device.

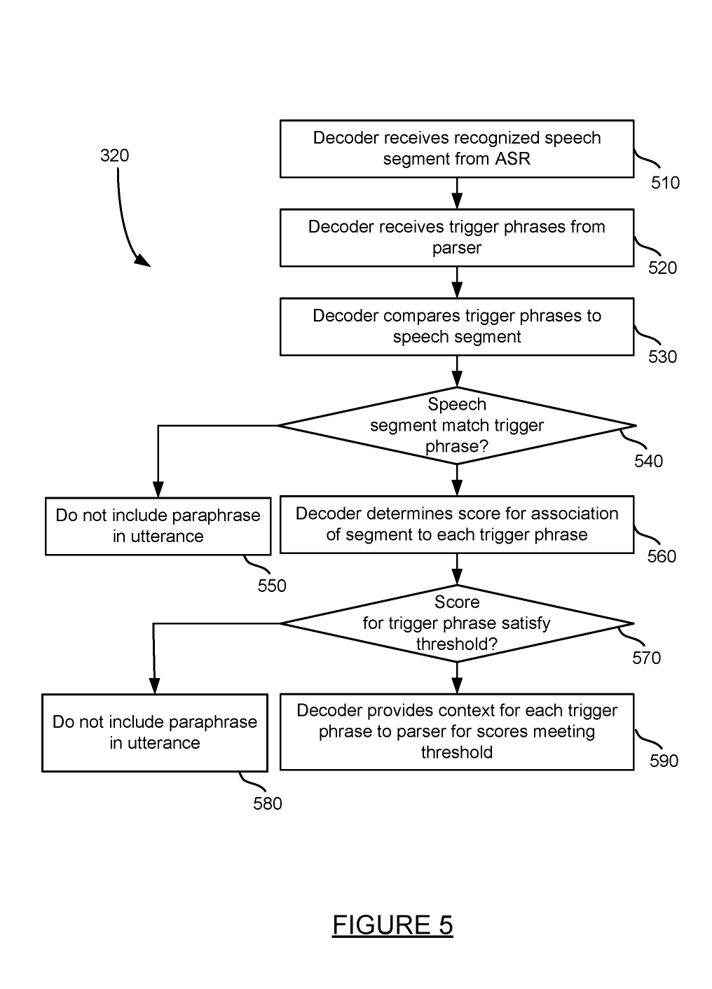

segments of the language input replaced with paraphrases by decoder module 230 at step 320. The segments, or in some instances the entire sentence, may be replaced in order to make the language input more easily parsed by parser 220. Placing segments of language input with paraphrases by decoder module 230 is discussed in more detail below with respect to the method of FIG. 5.

Received segments or sentence is parse and actions are created from the parsed language input with paraphrases by parser 220 at step 330. Parsing the segments and creating actions from the input may result in a display as a lattice or sausage network exemplary sausage network graph is illustrated in FIG. 4.

Actions may be performed in a structured output may be created by computation module 340. The computation module may receive and examine candidate responses, such as plants associated with a card created by parser 220. Candidate responses may be ranked, altered, and may be added to the additional cards created by computation module 240. Cavitation module then decides which plan or card to execute, for example by machine learning methodologies. Corresponding plan is then provided generator 250.

A string output is created by generator 250 at step 350. A logical form is received by generator 250 that may be comprised of key-value pairs. Generator 250 may generate a natural response from the logical form. In some instances, generator 250 may access salience information from state manager 260, when the salience information includes selling entities tracked during a conversation with the user. The natural language response may be in the form of a string that is provided to the output paraphrase module (translator) 270.

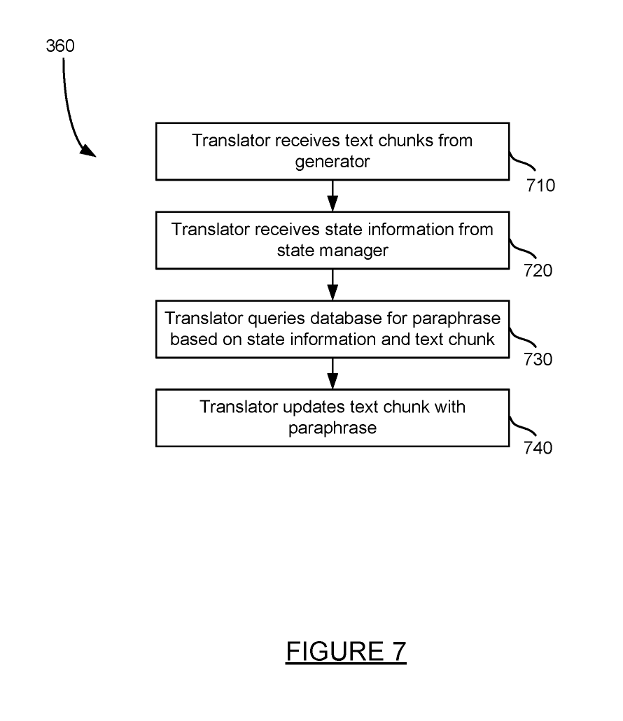

The output is updated with a paraphrase by translator module 270 at step 360. Updating the output may include modifying the output, writing a response, remove redundant portions of a segment for utterance, and other updates. More detail regarding updating output by a paraphrase module is discussed with respect to FIG. 7.

After updating an output with one or more paraphrases, the updated output is provided to a user at step 370. Providing output to a user include transmitting modified output to a remote machine such as client 110, mobile device 120, or computing device 134 the output utterance to be provided communicated to the user.

FIG. 5 is a method for replacing segments of language input with paraphrases by a decoder. The method of FIG. 5 provides more detail for step 320 the method FIG. 3. A decoder receives recognized speech segments from automatic speech recognizer module at step 510. The decoder may receive trigger phases from a parser at step 520. The trigger phrases may be retrieved from a database accessible by parser 220 such as database 222 the method of FIG. 2.

The decoder compares the trigger phrases to the speech segments at step 530. A determination is made as to whether the speech segments match one or more trigger phrases at step 540. The speech segment is compared to the trigger phrases such that if the speech segment matches a trigger phase, which may include a training sentence use to train a parser, the utterance can be easily parsed and no changes are made. Hence, no paraphrases are included in the utterance at step 550 if the speech segment matches a trigger phrase. If the speech segment does not match paraphrase, then decoder 230 determines a score for an association of a particular segment to each trigger phase at step 560.

A determination is then made as to whether the score for a trigger phrase satisfies a threshold at step 570. If the threshold is not satisfied, no paraphrases are included in the utterance because the trigger phases are not a close enough match to the segment. If a trigger phrase does satisfy the threshold, the decoder may provide context for each trigger phrase to a parser for the scores meeting the threshold at step 590.

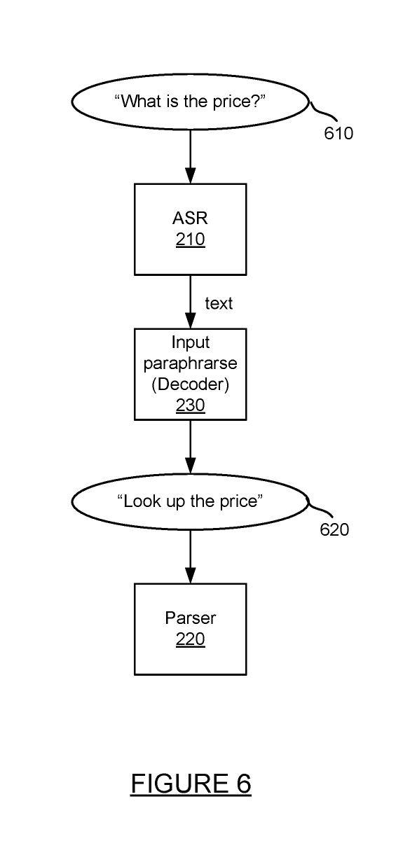

FIG. 6 is a flowchart showing a paraphrase provided by a decoder and added to an utterance. The flowchart begins with an utterance 610 received from a user. The utterance is audio content of “what is the price?” The utterance is received by automatic speech recognition module 210, converted to text, and then provided to input paraphrase module (decoder) 230. Decoder 230 may compare the text to trigger phrases, such as training sentences used to train parser 220. If there is an exact match, no paraphrase is added to the text. If there is no exact match, each training sentence and its association or relation to the input utterance is scored, and the highest scored trigger phrase or training sentence is selected and provided to parser 220. In the example of FIG. 6, the segment of the input utterance “what is” is replaced by a paraphrase “look up.”

FIG. 7 is a method for updating an output with paraphrase by a translator. The method of FIG. 7 provides more detail for step 360 of the method of FIG. 3. A translator receives textual chunks from a generator at step 710. The translator also receives state information from a state manager at step 720. The translator may then query the database for paraphrase content based on the state information and text chunk at step 730. The translator then updates to text chunk with paraphrase content at step 740.

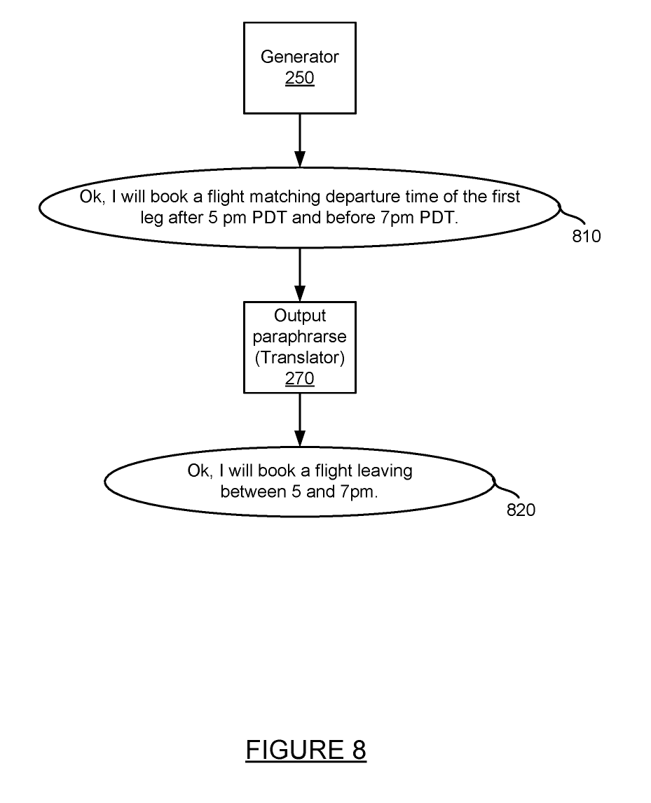

FIG. 8 is a flowchart showing a paraphrase provided by a translator and added to the generated output. The flowchart begins with a generator generating an output of “okay, I will book a flight matching departure time of the first leg after 5 PM PDT and before 7 PM PDT.” Jared output is then provided to the output paraphrase module 270 “translator”, which then paraphrases portions of the content to output.

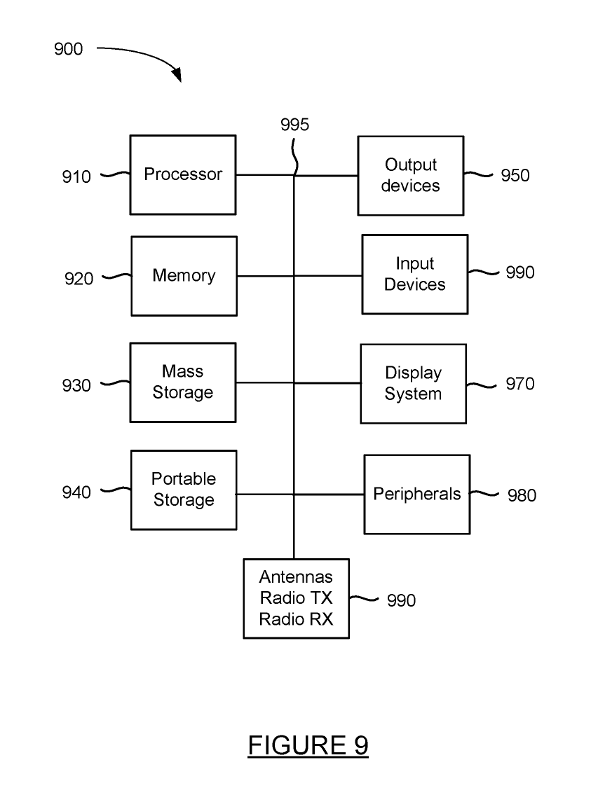

FIG. 9 is a block diagram of a computer system 900 for implementing the present technology. System 900 of FIG. 9 may be implemented in the contexts of the likes of client 610, mobile device 620, computing device 630, network server 650, application server 660, and data stores 670.

The computing system 900 of FIG. 9 includes one or more processors 910 and memory 920. Main memory 920 stores, in part, instructions and data for execution by processor 910. Main memory 910 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable or remote storage device 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing embodiments of the present invention for purposes of loading that software into main memory 620.

Portable storage device 940 operates in conjunction with a portable non-volatile storage medium, such as a compact disk, digital video disk, magnetic disk, flash storage, etc. to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys. Additionally, the system 900 as shown in FIG. 9 includes output devices 950. Examples of suitable output devices include speakers, printers, network interfaces, and monitors.

Display system 970 may include a liquid crystal display (LCD), LED display, touch display, or other suitable display device. Display system 970 receives textual and graphical information, and processes the information for output to the display device. Display system may receive input through a touch display and transmit the received input for storage or further processing.

Peripherals 980 may include any type of computer support device to add additional functionality to the computer system. For example, peripheral device(s) 980 may include a modem or a router.

The components contained in the computer system 900 of FIG. 9 can include a personal computer, hand held computing device, tablet computer, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Apple OS or iOS, Android, and other suitable operating systems, including mobile versions.

When implementing a mobile device such as smart phone or tablet computer, or any other computing device that communicates wirelessly, the computer system 900 of FIG. 9 may include one or more antennas, radios, and other circuitry for communicating via wireless signals, such as for example communication using Wi-Fi, cellular, or other wireless signals.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A system for providing an automated assistant, comprising:
an automatic speech recognition module stored in memory and executable by a processor that when executed receives speech data, recognizes words of a language in the speech, and outputs word data based on the recognized words; and
a paraphrase decoder stored in memory and executable by a processor that when executed identifies a first set of one or more words in the recognized words, selects a paraphrase associated with the first set of words, and generates a paraphrase decoder output including a paraphrase associated with the first set of words and the recognized words other than the first set of words, the paraphrase selected based on trigger phrases associated with a parser.

2. The system of claim 1, further comprising an automated assistant that performs a task and generates a response based on the paraphrase decoder output.

3. The system of claim 1, further including a parser that provides the trigger phrases to the paraphrase decoder.

4. The system of claim 3, wherein the trigger phrases include data used to train the parser

5. The system of claim 3, wherein the paraphrase decoder selects a paraphrase that allows the recognized words to be more easily parsed by the parser.

6. The system of claim 3, wherein the parser parses the recognized words based at least in part on state information.

7. The system of claim 1, further comprising a translator that creates training input sentences from the paraphrase decoder output.

8. A system for providing an automated assistant, comprising:
A generator module stored in memory and executable by a processor that when executed receives a speech structure form and renders a string of words based on the structure form; and
a paraphrase translator stored in memory and executable by a processor that when executed identifies a first set of words in the string of words, selects a paraphrase associated with the first set of words, and generates a paraphrase translator output including a paraphrase associated with the first set of words and the recognized words other than the first set of words, the paraphrase selected based at least in part on state information.

9. The system of claim 8, wherein the paraphrase translator removes a chunk of the string of words based on the state information.

10. The system of claim 8, wherein the paraphrase translator replaces a chunk of the string of words based on the state information.

11. The system of claim 8, wherein the paraphrase translator generates a paraphrase to make the string of words sound more natural.
